(19) United States
(12) Patent Application Publication
(10) Pub. No.: US 2008/0020358 A1
(43) Pub. Date: Jan. 24, 2008

(54) Favored position globe

(76) Inventor: Karen Keith, Lorena, TX (US)

Correspondence Address: Steven Thrasher, 391 Sandhill Dr., Richardson, TX, 75080, US

(21) Appl. No.: 11/483,334

(22) Filed: Jul. 8, 2006

(51) Int. Cl. G09B 25/06

(52) U.S. Cl. 434/130

(57) ABSTRACT

The invention is a favored position globe. The globe includes a stand, a frame having an inside radius slightly larger than a radius of a cross-section of the globe, the globe having an interior, and also having a weight secured to a location in the interior, such that the sphere has a single predictable orientation when at rest. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### TECHNICAL FIELD OF THE INVENTION

The invention relates generally to geographical-type globes.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Mankind has known that the Earth is a sphere since the time of antiquity—since probably Pythagoras in 500 B.C., and certainly no later than when Eratosthenes knew in about 300 BC that no shadows on the Summer Solstice meant that the city of Syene was on the boundary of the northern tropic zone and thus knew the circumference of the Earth. Since then, to represent the Earth, geographers and map-makers have created spherical geographic globes to represent the Earth.

However, because people are dispersed, so are perspectives. This has led to many globes positioning the continent of Australia as being “up” in perspective. At least one globe even identifies Tiananmen Square in China as the universally centered location. However, even when a globe is “repositioned” and at rest it may still spin such that the viewers home location is out of sight.

Because everyone has a personal perspective of the world, and usually seeks to represent the Earth from their point of view, it would advantageous to provide a device that allows for the position-favored orientation of a globe. The present invention provides such a device.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 illustrates a favored position globe that uses selectively positioned rate to hold a globe in a preferred orientation.

FIG. 2 is a top-down view of the favored position globe.

FIG. 3 is a perspective view of the favored position globe.

FIG. 4 shows a favored position globe using at least one selectively positioned magnetic force to hold a globe in preferred position or orientation.

FIG. 5a is a bottom-up view of the favored position globe.

FIG. 5b shows greater detail of a magnetic assembly.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Of course, the foregoing discussions and definitions are provided for clarification purposes and are not limiting. Words and phrases are to be given their ordinary plain meaning unless indicated otherwise.

### DESCRIPTION OF THE DRAWINGS

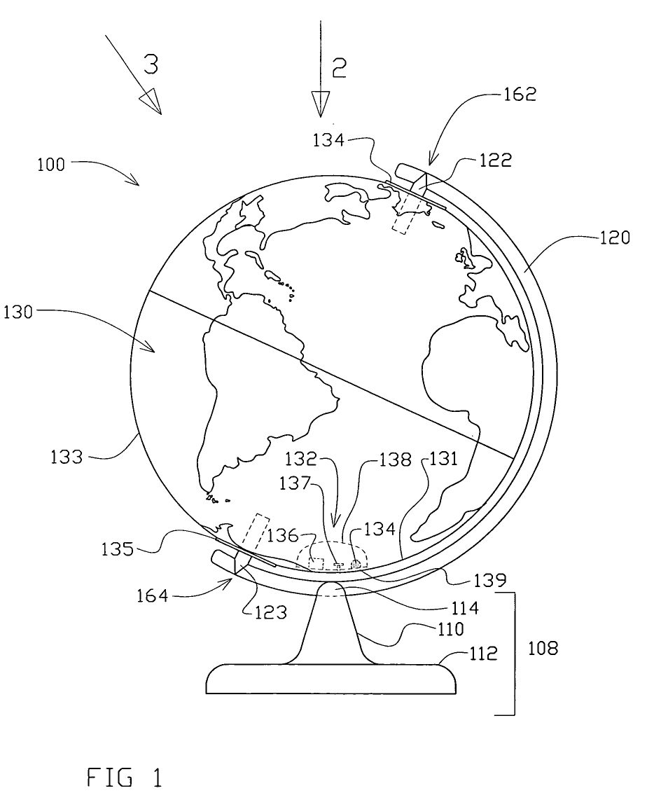

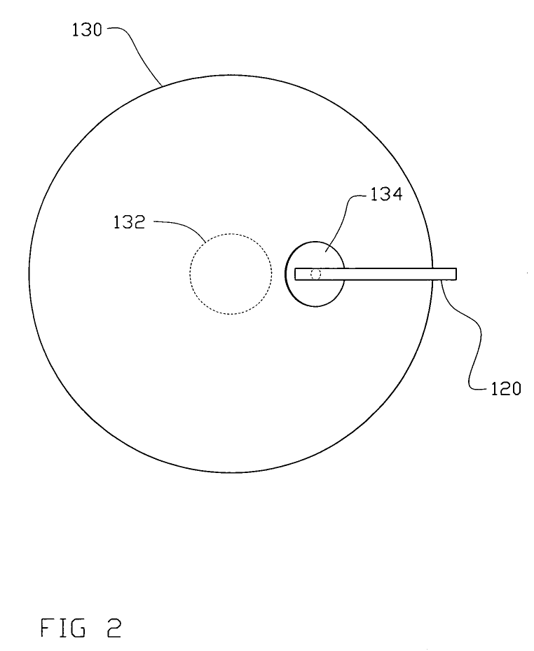

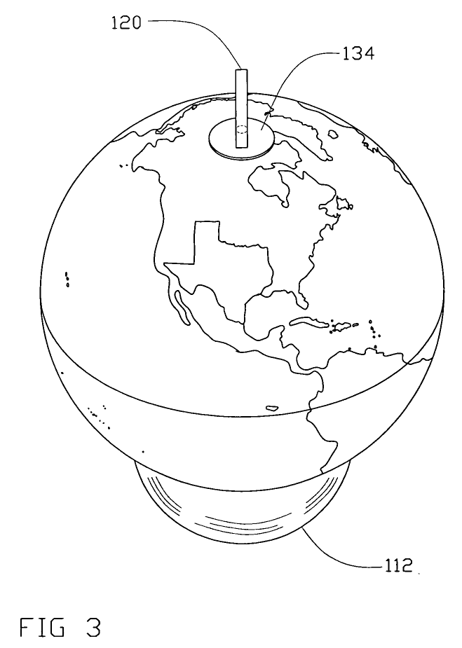

One embodiment of the invention may be described as a favored position globe 100, and is described herein with simultaneous reference to FIGS. 1 through FIGS. 3. FIG. 1 illustrates a favored position globe 100 that uses selectively positioned weight 132 to position a globe 130 in a preferred orientation. Likewise, FIG. 2 is a top-down view of the favored position globe 100 viewed from the position arrow 2 of FIG. 1. Similarly, and FIG. 3 is a perspective view of the favored position globe 100 viewed from the position arrow 3 of FIG. 1.

The favored position globe 100 may be characterized as a globe 130 and stand system 108. In general, the stand system 108 may be characterized as comprising a base 112 and an elevating pedestal 110. The base 112 allows the favored position globe 100 to sit upon a surface, and those familiar with the art of globes will readily recognize the numerous substitutions and equivalents that may be supplied for the stand system 108 and its elements. The elevating pedestal 110 provides aesthetic appeal to the favored positioned globe 100, and also provides a slot 114 in which a frame 120 is secured. The application of the frame 120 to the slot 114 is readily apparent to those of ordinary skill in the art.

The frame 120 is shaped as at least a portion of a circle (such as an arc, as shown), and thus is generally curvilinear, or circular in curvature. However, it will be appreciated by those in the globe making arts that the earth is not a perfect sphere and as such the frame 120 need not be shaped like a portion of a perfect circle, or a complete circle. The frame 120 has a first axial point 162 and a second axial point 164. Each axial point has secured thereto an axle 162, 164. Of course, it will be appreciated that to provide a spinning action to the globe a single axle 122 may traverse between the axial points 162, 164. The frame 120 generally has an inside radius defined as the interior-most portion (the portion most proximate to the globe 130) of the frame 120, and the radius is slightly larger than a radius of a cross section of a globe 130.

The globe 130 is nearly universally recognized by its spherical shape, and its exterior surface 133 upon which at least some of the continents of the earth are expressed (of course, it is understood that early globes did not include the continents of North and South America, or even all the areas of Asia, the Polar Zones, India, and many islands) because these areas had not been discovered and mapped at the times the globes were made). The globe 130 is typically made of a cardboard, plastic, or metal material with the continents and water bodies of the earth either painted or printed directly upon the exterior surface 133, or pre-printed on paper or plastic and then stuck to the globe with glue or other adhesive. However, it will be appreciated that the material of which the globe is made and manner of manufacture, no matter what kind, is incorporated within the scope of the invention. The globe 130 has an interior surface 131. A first washer 134 and a second washer 135 are typically secured to the exterior surface 133 up the globe 130 about axle receiving holes in the globe 130 to prevent the holes in the globe from expanding due to mechanical forces known in the art. Accordingly, the globe 130 thus may spin about the axles 122 and 123.

The favored position globe 100 includes within the interior of the globe 130, the weight 132, which is here secured in a pouch 138. The weight 132 or the pouch 138 may be securely coupled to the interior surface 131 with an adhesive 139, such as glue, or may mechanically be coupled to the interior surface 131 with, for example, a tack 137. The weight 132 may comprise sand 134, metal 136, or any other material that when secured to the interior surface 131 causes the globe 130 to take a favored position and orientation. For example, one may see by simultaneous reference to FIG. 1 and FIG. 3, that the weight 132 is secured to the interior surface 131 of the globe 130 such that the state of Texas has a favored upward orientation, and thus the globe 130 has a favored position when it is at rest, or, in other words, a favored position when in a static state.

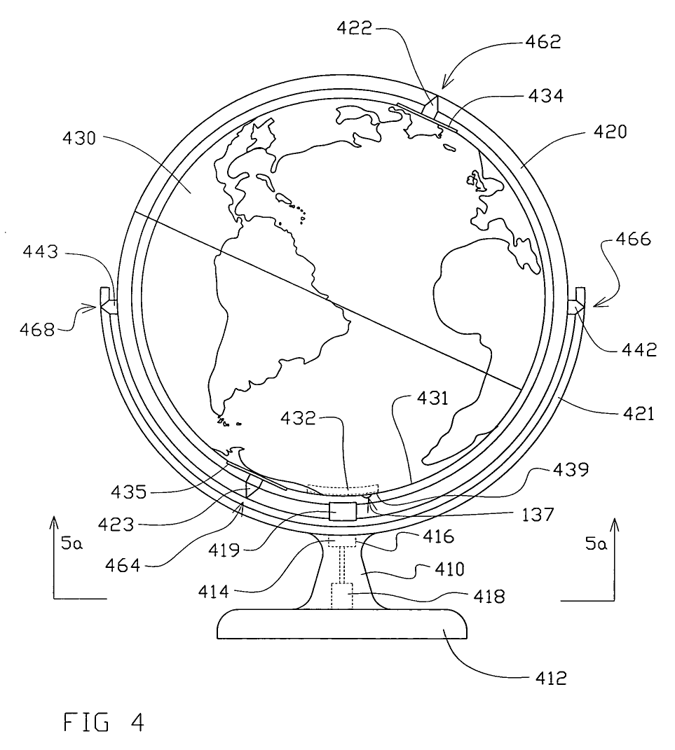

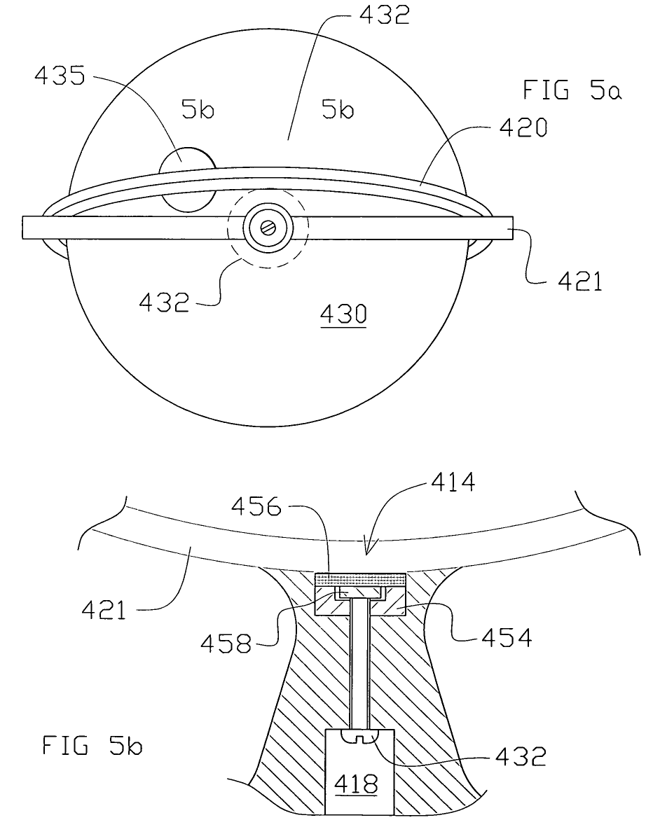

FIGS. 4 through 5b illustrate an alternative embodiment of a favored position globe 400 incorporating features that may be incorporated into the favored position globe 100. FIG. 4 shows a favored position globe using at least one selectively positioned magnetic force to hold a globe 430 in preferred position or orientation. FIG. 5a is a bottom-up view of the favored position globe 400 taken off the cut line 5a-5a of FIG. 4, while FIG. 5b shows greater detail of a magnetic assembly 414 taken across the cut line 5b-5b of FIG. 5a. Accordingly, the following discussion is best understood with simultaneous reference to FIGS. 4 through 5b.

The favored position globe 400 includes a stand 408. The stand system generally comprising a base 412 and an elevating pedestal 410. The elevating pedestal of the favored position globe 400 further comprises a cavity 416 and a mounting channel 418. The cavity 416 is generally shaped to accept a magnetic assembly 414, while the mounting channel 418 provides a bolt access to secure the magnetic assembly 414 in the cavity 416 in a manner such as that discussed below, which is readily apparent to those of skill in the art upon reading the present disclosure. Further, a frame 421 may rest in, or be secured to, the elevating pedestal 410 in any manner known in the globe arts.

The frame 421 is coupled to a second frame 420. The second frame 420 is at least curvilinear, but preferably circular, and preferably circumnavigates the globe 430. The second frame 420 includes a first axial point 462 having a first axle 422 attached thereto, as well as second axial point 464 having a second axle 423 attached thereto. The first axle 422 extends through a hole (not shown, but readily understood to those of skill in the art) in a washer 434 that is coupled to the globe 430, and similarly, the second axle 423 extends through a hole in a second washer 435. Returning to the first frame 421, which is preferably curvilinear, there is thereon a third axle point 466 and a fourth axle point 468, the third axle point 466 having a attached thereto a third axle 442, and the fourth axle point 468 having attached thereto a fourth axle 443. The third axle 442 and the fourth axle 443 are rotateably coupled to the second frame 420 in a manner known to those of skill in the globe making art. Either the first frame 421, or as shown here, the second frame 420 may have a positional frame portion 419 coupled thereto, preferably in a manner that allows the magnet to securely slide about the frame to which it is attached.

The globe 430 has an interior surface 431 as well as an exterior surface 433. As discussed above with reference to the globe 130, the exterior surface generally expresses at least one of the continents of the earth. The interior 431 has coupled thereto an attractable member 432, which is magnetically reactive—meaning that it may be a magnet, or a magnetically responsive metal. The attractable member 432 is coupled to the interior surface 431 with an adhesive 439, and may be independently or reinforceably coupled to the interior surface 431 with a mechanical device, such as a rivet. 137. Of course, although the attractable member 432 is shown here coupled to the interior surface 431, in some alternative embodiments the attractable member 432 may be secured to the exterior surface 433 of the globe 430.

FIG. 5b illustrates greater detail of the magnetic assembly 414 that is secured in the elevating pedestal 410. Here, one can see the frame 421 coupled to the elevating pedestal, and observe a clear view of the mounting channel 418 and the cavity 416. A second attachable member 456, such as a magnet, is shown coupled to a seat 454. In addition, a threaded coupling 458, such as a nut, is secured to the second attachable member 456, such that a bolt 432 may be inserted into the elevating pedestal 410 and mate with the threaded coupling 458 to pull the second attractable member 456 to the seat 454.

Accordingly, at least one of the attractable members 432, 456 is magnetic, and the other may be magnetic or metallic, and it is the choice of the maker or user of the favored position globe 400 to make the appropriate choice. Alternatively, the positional frame portion 419 may be used to provide additional functionality to the favored position globe 400, or to eliminate the need for one of the magnetic assemblies. In addition, it is understood that the teachings of the invention provide for the combining of the weight-based and magnetic-based teaching to build a favored position globe. Accordingly, the positional frame portion 419 may actually be any of the materials that comprise an attractable member 432. Thus, in practice, when the globe 430 is in a state of rest or static state, two forces work to achieve the orientation of the favored position globe 400. First, the physical weight of the attractable member 432 causes the globe to find one orientation, while the magnetic inter-action of the attractable members 432, 456, and perhaps the positional frame portion 419, a preferred globe orientation and position is met, and held absent any outside intervention.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A favored position globe, comprising:
a stand system;
a curvilinear frame secured to the stand system and having a first axel point and a second axel point, and having an inside radius slightly larger than a radius of a cross-section of a sphere;
the sphere suspended between the first axel point and the second axel point via at least one axel; and
the sphere having an interior, and also having a weight secured to a location in the interior, such that the sphere has a single predictable orientation when at rest.

2. The globe of claim 1 wherein the stand system comprises an elevating pedestal that couples a surface-supporting base to the frame.

3. The globe of claim 1 wherein a first axel is secured to the first axel point.

4. The globe of claim 3 wherein a second axel is secured to the second axel point.

5. The globe of claim 1 wherein the weight comprises sand.

6. The globe of claim 1 wherein the weight comprises metal.

7. The globe of claim 1 wherein the sphere has an exterior generally expressing at least on continent of Earth.

8. The globe of claim 1 further comprising a first washer disposed about the axel, the first washer also being coupled to the globe.

9. The globe of claim 1 wherein the weight is secured to the interior with glue.

10. The globe of claim 1 wherein the weight is secured to the interior via a mechanical means.

11. The globe of claim 1 further comprising a second frame coupled between the frame and the sphere, the second frame being curvilinear, having a first axel point and a second axel point, and having an inside radius slightly larger than the radius of the frame.
